(19) United States
(12) Patent Application Publication
(10) Pub. No.: US 2025/0111864 A1
(43) Pub. Date: Apr. 3, 2025

(54) MAGNETIC RECORDING MEDIUM, MAGNETIC TAPE CARTRIDGE, AND MAGNETIC RECORDING AND REPRODUCING DEVICE

(71) Applicant: FUJIFILM Corporation, Tokyo (JP)

(72) Inventor: Masahiko MORI, Minamiashigara-shi (JP)

(73) Assignee: FUJIFILM Corporation, Tokyo (JP)

(21) Appl. No.: 18/899,572

(22) Filed: Sep. 27, 2024

(30) Foreign Application Priority Data
Sep. 28, 2023 (JP) 2023-166843

(51) Int. Cl. G11B 5/65; G11B 5/008; G11B 5/66

(52) U.S. Cl. CPC G11B 5/653; G11B 5/00813; G11B 5/66

(57) ABSTRACT

The magnetic recording medium includes: a non-magnetic support; a magnetic layer containing a ferromagnetic powder; and a non-magnetic layer containing a non-magnetic powder between the non-magnetic support and the magnetic layer, in which a total chlorine content of the magnetic layer and the non-magnetic layer is 30.0 mg/m² or less as a value per unit area, and a total iron content of the magnetic layer and the non-magnetic layer is 300.0 mg/m² or less as a value per unit area.

### CROSS-REFERENCE TO RELATED APPLICATIONS

This application claims priority under 35 U.S.C 119 to Japanese Patent Application No. 2023-166843 filed on Sep. 28, 2023. The above application is hereby expressly incorporated by reference, in its entirety, into the present application.

### BACKGROUND OF THE INVENTION

### 1. Field of the Invention

The present invention relates to a magnetic recording medium, a magnetic tape cartridge, and a magnetic recording and reproducing device.

### 2. Description of the Related Art

As a magnetic recording medium, a medium having a configuration including a magnetic layer and a non-magnetic layer has been known (see, for example, JP2020-144960A, JP2004-103067A, and JP2005-267714A).

### SUMMARY OF THE INVENTION

A performance desired for the magnetic recording medium includes excellent electromagnetic conversion characteristics. Regarding the electromagnetic conversion characteristics, for example, JP2020-144960A discloses that a magnetic tape of the examples has little deterioration in electromagnetic conversion characteristics after repeated running in an environment of a temperature of 23° C. and a relative humidity of 45% (see paragraph 0119, Table 1, and paragraph 0123 of JP2020-144960A). In response to this, the present inventor has considered that, in the future, the magnetic recording medium is also expected to be used after being stored under severe conditions (for example, storage in a high temperature environment, storage in a high humidity environment, and/or long-term storage).

An object of one aspect of the present invention is to provide a magnetic recording medium that includes a magnetic layer and a non-magnetic layer and that has little deterioration in electromagnetic conversion characteristics after storage under severe conditions.

One aspect of the present invention is as follows.

[1]A magnetic recording medium comprising:
a non-magnetic support;
a magnetic layer containing a ferromagnetic powder; and
a non-magnetic layer containing a non-magnetic powder between the non-magnetic support and the magnetic layer,
in which a total chlorine content of the magnetic layer and the non-magnetic layer is 30.0 mg/m² or less as a value per unit area, and
a total iron content of the magnetic layer and the non-magnetic layer is 300.0 mg/m² or less as a value per unit area.

[2] The magnetic recording medium according to [1],
in which a void ratio of the non-magnetic layer is 10.0% or less in a cross section image captured by a scanning electron microscope.

[3] The magnetic recording medium according to [1] or [2],
in which the non-magnetic powder of the non-magnetic layer includes carbon black.

[4] The magnetic recording medium according to [3],
in which the non-magnetic layer contains 50.0% by mass or more of carbon black with respect to a total amount of the non-magnetic powder.

[5] The magnetic recording medium according to any one of [1] to [4],
in which a thickness of the non-magnetic layer is 1.00 m or less.

[6] The magnetic recording medium according to any one of [1] to [5], further comprising:
a back coating layer containing a non-magnetic powder on a surface side of the non-magnetic support opposite to a surface side having the non-magnetic layer and the magnetic layer.

[7] The magnetic recording medium according to any one of [1] to [6],
in which the magnetic recording medium is a magnetic tape.

[8] The magnetic recording medium according to [1],
in which a void ratio of the non-magnetic layer is 10.0% or less in a cross section image captured by a scanning electron microscope,
the non-magnetic layer contains 50.0% by mass or more of carbon black with respect to a total amount of the non-magnetic powder,
a thickness of the non-magnetic layer is 1.00 m or less,
the magnetic recording medium further comprises a back coating layer containing a non-magnetic powder on a surface side of the non-magnetic support opposite to a surface side having the non-magnetic layer and the magnetic layer, and
the magnetic recording medium is a magnetic tape.

[9]A magnetic tape cartridge comprising:
the magnetic tape according to [7] or [8].

[10]A magnetic recording and reproducing device comprising:
the magnetic recording medium according to any one of [1] to [8].

According to one aspect of the present invention, it is possible to provide a magnetic recording medium that includes a magnetic layer and a non-magnetic layer and that has little deterioration in electromagnetic conversion characteristics after storage under severe conditions. In addition, according to one aspect of the present invention, it is possible to provide a magnetic tape cartridge and a magnetic recording and reproducing device including the magnetic recording medium.

### DESCRIPTION OF THE PREFERRED EMBODIMENTS

### Magnetic Recording Medium

One aspect of the present invention relates to a magnetic recording medium including a non-magnetic support, a magnetic layer containing a ferromagnetic powder, and a non-magnetic layer containing a non-magnetic powder between the non-magnetic support and the magnetic layer. A total chlorine content of the magnetic layer and the non-magnetic layer is 30.0 mg/m² or less as a value per unit area (hereinafter, also referred to as “chlorine content (magnetic layer+non-magnetic layer)”), and a total iron content of the magnetic layer and the non-magnetic layer is 300.0 mg/m² or less as a value per unit area (hereinafter, also referred to as “iron content (magnetic layer+non-magnetic layer)”).

Measuring method of Chlorine Content (Magnetic Layer+Non-Magnetic Layer) and Iron Content (Magnetic Layer+Non-Magnetic Layer)

The “chlorine content (magnetic layer+non-magnetic layer)” and the “iron content (magnetic layer+non-magnetic layer)” in the present invention and the present specification are obtained by the following methods.

(1) A measurement sample piece is cut out from the magnetic recording medium to be measured. A size of the sample piece need only be a size appropriate for being introduced into an X-ray fluorescence analysis apparatus.

(2) The cut sample piece is introduced into the X-ray fluorescence analysis apparatus, and the amount of Cl is measured from a peak surface area of a chlorine (Cl) element, and the amount of Fe is measured from a peak surface area of an iron (Fe) element.

(3) After the measurement of (2), the sample piece is taken out from the X-ray fluorescence analysis apparatus, and the magnetic layer and the non-magnetic layer are wiped and removed with a solvent. The solvent used here need only be a solvent capable of removing the magnetic layer and the non-magnetic layer. Thereafter, the sample piece is introduced into the X-ray fluorescence analysis apparatus, and the amount of Cl is measured from the peak surface area of the Cl element, and the amount of Fe is measured from the peak surface area of the Fe element. As a result, in the magnetic recording medium including a back coating layer, the total amount of Cl and the total amount of Fe in the back coating layer and the non-magnetic support are obtained. For the magnetic recording medium including no back coating layer, the amount of Cl and the amount of Fe of the non-magnetic support are obtained.

(4) The “chlorine content (magnetic layer+non-magnetic layer)” and the “iron content (magnetic layer+non-magnetic layer)” are calculated by the following expressions.

Chlorine content (magnetic layer+non-magnetic layer) (mg/m²)=[amount of Cl obtained in (2) described above −amount of Cl obtained in (3) described above]/area of sample piece

Iron content (magnetic layer+non-magnetic layer) (mg/m²)=[amount of Fe obtained in (2) described above−amount of Fe obtained in (3) described above]/area of sample piece

The present inventor has intensively studied in order to provide a magnetic recording medium that includes a magnetic layer and a non-magnetic layer and that has little deterioration in electromagnetic conversion characteristics after storage under severe conditions. As a result, it has been newly found that a magnetic recording medium in which the chlorine content (magnetic layer+non-magnetic layer) and the iron content (magnetic layer+non-magnetic layer) are within the above-described ranges can suppress deterioration in electromagnetic conversion characteristics after storage under severe conditions. Regarding this point, the present inventor has supposed that the chlorine element and the iron element contained in the magnetic layer and/or the non-magnetic layer may cause deterioration in magnetic properties of the ferromagnetic powder included in the magnetic layer, deterioration in a film of the magnetic layer, and/or deterioration in a film of the non-magnetic layer during storage under severe conditions. On the other hand, the present inventor considers that, in the magnetic recording medium in which the chlorine content (magnetic layer+non-magnetic layer) and the iron content (magnetic layer+non-magnetic layer) are within the above-described ranges, such deterioration can be suppressed, and as a result, it is possible to suppress the deterioration in electromagnetic conversion characteristics after storage under severe conditions. Note that the present invention is not limited to the supposition described in the present specification.

With respect to this, the previously mentioned JP2020-144960A, JP2004-103067A, and JP2005-267714A do not suggest that either the chlorine content (magnetic layer+non-magnetic layer) or the iron content (magnetic layer+non-magnetic layer) should be reduced.

### Chlorine Content (Magnetic Layer+Non-Magnetic Layer)

From the viewpoint of suppressing the deterioration in electromagnetic conversion characteristics after storage under severe conditions, the chlorine content of the magnetic recording medium (magnetic layer+non-magnetic layer) is 30.0 mg/m² or less, preferably 28.0 mg/m² or less, and more preferably 25.0 mg/m² or less, 20.0 mg/m² or less, 15.0 mg/m² or less, and 10.0 mg/m² or less in this order. The chlorine content of the magnetic recording medium (magnetic layer+non-magnetic layer) may be, for example, 0.0 mg/m² or more, more than 0.0 mg/m², 1.0 mg/m² or more, 2.0 mg/m² or more, 3.0 mg/m² or more, 4.0 mg/m² or more, or 5.0 mg/m2 or more. From the viewpoint of suppressing the deterioration in electromagnetic conversion characteristics after storage under severe conditions, the smaller the chlorine content of the magnetic recording medium (magnetic layer+non-magnetic layer), the more preferable it is.

### Iron Content (Magnetic Layer+Non-Magnetic Layer)

From the viewpoint of suppressing the deterioration in electromagnetic conversion characteristics after storage under severe conditions, the iron content (magnetic layer+non-magnetic layer) of the magnetic recording medium is 300.0 mg/m² or less, preferably 280.0 mg/m² or less, and more preferably 250.0 mg/m² or less, 200.0 mg/m² or less, 150.0 mg/m² or less, and 100.0 mg/m² or less in this order. The iron content (magnetic layer+non-magnetic layer) of the magnetic recording medium may be, for example, 0.0 mg/m² or more, more than 0.0 mg/m², 1.0 mg/m² or more, 5.0 mg/m² or more, 10.0 mg/m² or more, 20.0 mg/m² or more, 30.0 mg/m² or more, 40.0 mg/m² or more, 50.0 mg/m² or more, 60.0 mg/m² or more, 70.0 mg/m² or more, 80.0 mg/m² or more, or 90.0 mg/m² or more. From the viewpoint of suppressing the deterioration in electromagnetic conversion characteristics after storage under severe conditions, the smaller the iron content of the magnetic recording medium (magnetic layer+non-magnetic layer), the more preferable it is.

Hereinafter, the magnetic recording medium will be further described in detail.

### Thicknesses of Each Layer and Non-Magnetic Support

The magnetic recording medium includes the non-magnetic layer and the magnetic layer, and in one aspect, the magnetic recording medium may further include a back coating layer containing a non-magnetic powder on a surface side of the non-magnetic support opposite to a surface side having the non-magnetic layer and the magnetic layer. In another aspect, the magnetic recording medium may be a magnetic recording medium that does not include such a back coating layer.

A thickness of the magnetic layer can be optimized according to saturation magnetization amount of the magnetic head used, a head gap length, a recording signal band, and the like. The thickness of the magnetic layer is preferably 100 nm or less, more preferably 10 to 100 nm, and still more preferably 20 to 90 nm, from the viewpoint of high-density recording. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers. The same applies to a case where the other layers are separated into two or more layers.

From the viewpoint of increasing a capacity of the magnetic recording medium, a thickness of the non-magnetic layer is preferably 1.00 m or less, more preferably 0.80 m or less, and still more preferably 0.60 m or less. In addition, from the viewpoint of ease of uniformly applying a composition for forming a non-magnetic layer, the thickness of the non-magnetic layer is preferably 0.05 m or more, more preferably 0.07 m or more, and still more preferably 0.10 m or more. In general, the non-magnetic layer may be a layer thicker than the magnetic layer (for example, the thickness of the non-magnetic layer is equal to or more than 2 times, 3 times, 4 times, or 5 times the thickness of the magnetic layer). Therefore, it can be said that the contribution of the magnetic layer component to the chlorine content (magnetic layer+non-magnetic layer) and the iron content (magnetic layer+non-magnetic layer) is negligibly small.

A thickness of the back coating layer is preferably 0.90 m or less and more preferably in a range of 0.10 to 0.70 m.

A thickness of the non-magnetic support is, for example, in a range of 2.0 to 80.0 m, preferably in a range of 2.0 to 50.0 m, and more preferably in a range of 2.0 to 10.0 m.

### Non-Magnetic Layer

### Void Ratio of Non-Magnetic Layer

From the viewpoint of improving the electromagnetic conversion characteristics by increasing a saturation magnetic flux density Bm of the magnetic layer, a void ratio of the non-magnetic layer of the magnetic recording medium is preferably 20.0% or less, and more preferably 19.0% or less, 18.0% or less, 17.0% or less, 16.0% or less, 15.0% or less, 14.0% or less, 13.0% or less, 12.0% or less, 11.0% or less, 10.0% or less, 9.0% or less, 8.0% or less, 7.0% or less, 6.0% or less, and 5.0% or less in this order. In addition, from the viewpoint of formability in a calender treatment, the void ratio of the non-magnetic layer is, for example, preferably 0.8% or more, more preferably 1.0% or more, still more preferably 1.2% or more, still more preferably 1.5% or more, and still more preferably 2.0% or more.

Regarding the reason why the saturation magnetic flux density Bm of the magnetic layer can be increased by reducing the void ratio of the non-magnetic layer, the present inventor has supposed as follows.

The composition for forming a non-magnetic layer usually contains a binding agent. From the viewpoint of improving the dispersibility of the non-magnetic powder in the non-magnetic layer and improving the film hardness of the non-magnetic layer, it is desirable that the binding agent is adsorbed on the particle surface of the non-magnetic powder as much as possible, but it is usually considered that the entire amount is not adsorbed. Therefore, it is supposed that a liberatable non-adsorbed binding agent component is present in the non-magnetic layer in a state of being mixed with the adsorbed binding agent component. It is considered that the non-adsorbed binding agent component of the non-magnetic layer passes through a void between the non-magnetic powder and the adsorbed binding agent component and permeates into the inside of the magnetic layer in a manufacturing step of the magnetic recording medium. In a case where the non-magnetic components of the magnetic layer increase as a result, a ratio of the ferromagnetic powder to the volume of the magnetic layer decreases. It is supposed that this is a cause of a decrease in the saturation magnetic flux density Bm of the magnetic layer. Therefore, the present inventor considers that, in a case where the void ratio of the non-magnetic layer is reduced, the saturation magnetic flux density Bm of the magnetic layer can be increased as a result.

In the present invention and the present specification, the void ratio of the non-magnetic layer is a value obtained in a cross section image obtained using a scanning electron microscope (SEM). A method for obtaining the void ratio of the non-magnetic layer will be described below.

### (1) Manufacture of Sample for Observing Cross Section

A sample for observing a cross section is manufactured by being cut out from a randomly determined position on the magnetic recording medium to be measured. The manufacture of the sample for observing a cross section is performed by focused ion beam (FIB) processing using a gallium ion (Ga⁺) beam. Specific examples of the manufacturing method are as follows.

(i) A sample having a size of 10 mm in a width direction×10 mm in a longitudinal direction of the magnetic recording medium is cut out using a cutter.

A protective film is formed on a magnetic layer surface of the cut sample to obtain a sample with a protective film. The protective film is formed by the following method.

A platinum (Pt) film (thickness of 30 nm) is formed on the magnetic layer surface of the sample by sputtering. The sputtering of the platinum film is performed under the following conditions.

### Sputtering Condition for Platinum Film

Target: Pt
Degree of vacuum in chamber of sputtering device: 7 Pa or less
Current value: 15 mA

A carbon film having a thickness of 100 to 150 nm is further formed on the above-manufactured sample with a platinum film. The formation of the carbon film is performed by a chemical vapor deposition (CVD) mechanism using a gallium ion (Ga⁺) beam provided in a focused ion beam (FIB) device used in the following (ii).

(ii) FIB processing using a gallium ion (Ga⁺) beam is performed on the sample with a protective film manufactured in the above (i) using a FIB device to expose a cross section of the magnetic recording medium. An acceleration voltage in FIB processing is 30 kV, and a probe current is 1300 pA.

For example, the sample for observing a cross section exposed in this manner is used for the SEM observation for obtaining the void ratio of the non-magnetic layer and the SEM observation for obtaining the magnetic layer thickness described below.

### (2) Specification of Non-Magnetic Layer

The manufactured sample for observing a cross section is observed with SEM, and a cross-sectional image (SEM image) is captured. As the scanning electron microscope, a field emission-scanning electron microscope (FE-SEM) is used. For example, FE-SEM S4800 manufactured by Hitachi, Ltd. can be used, and this FE-SEM was used in Examples and Comparative Examples described below.

The SEM image is captured at randomly selected positions in the same sample for observing a cross section, except that the positions are selected such that (i) imaging ranges do not overlap, (ii) the magnetic layer side outermost surface (magnetic layer surface) is included in the SEM image, and (iii) the entire thickness direction region (that is, a region from the magnetic layer side outermost surface to the other side outermost surface) of the sample for observing the cross section is included in the SEM image, or in a case where the entire thickness direction region of the sample for observing the cross section is not included in the SEM image, a proportion of an imaging portion of the sample for observing a cross section occupying the whole image area of the SEM image is 80% to 100% based on area. In this way, a total of 10 images are obtained.

The SEM images are secondary electron images (SE images) captured at an acceleration voltage of 5 kV, an imaging magnification of 50000×, and vertical 960 pixels×horizontal 1280 pixels.

The captured SEM image is taken into WinROOF which is manufactured by MITANI CORPORATION and is image processing software, and a portion (measurement region) of a non-magnetic layer in the SEM image is selected. In the selection of the measurement region, a length of the measurement region in a width direction is taken as a total width of the captured SEM image. The term “width direction” described in relation to the SEM image refers to a width direction in the imaged sample for observing a cross section. The width direction in the sample for observing a cross section is a width direction in a magnetic recording medium from which the sample is cut out. The same also applies to the thickness direction.

Regarding the thickness direction, the interface between the magnetic layer and the non-magnetic layer is specified by the following method. The SEM image is digitized to create image brightness data (consisting of three components: a coordinate in the thickness direction; a coordinate in the width direction; and a brightness) in the thickness direction. In the digitization, the SEM image is divided into 1280 pieces in the width direction, and processed with a brightness of 8 bits to obtain 256-gradation data, and the image brightness of each divided coordinate point is converted into a predetermined gradation value. Next, a brightness curve is created by setting an average value (that is, an average value of brightnesses at respective coordinate points divided into 1280 pieces) of brightnesses in the width direction at respective coordinate points in the thickness direction in the obtained image brightness data to a vertical axis, and setting a coordinate in the thickness direction to a horizontal axis. A differential curve is created by differentiating the created brightness curve, and the coordinates of the boundary between the magnetic layer and the non-magnetic layer are specified from a peak position of the created differential curve. A position corresponding to the specified coordinates on the SEM image is defined as an interface between the magnetic layer and the non-magnetic layer. In a case where a portion of the non-magnetic support is included in the SEM image, the interface between the non-magnetic layer and the non-magnetic support is specified. For example, in the coating type magnetic recording medium, the interface between the non-magnetic layer and the non-magnetic support is clearly recognizable, compared to the interface between the magnetic layer and non-magnetic layer. Therefore, the interface between the non-magnetic layer and the non-magnetic support can be specified by visually observing the SEM image. Note that the interface may be specified by using the brightness curve in the same manner as above. In a case where the SEM image does not include a portion of the non-magnetic support, the entire region of the portion of the non-magnetic layer in the thickness direction from the specific interface (that is, the non-magnetic layer surface) between the magnetic layer and the non-magnetic layer is specified as the non-magnetic layer. On the other hand, in a case where the SEM image includes the portion of the non-magnetic support, the entire region including the specified interface (that is, the surface of the non-magnetic layer on the magnetic layer side) between the magnetic layer and non-magnetic layer and the interface (that is, the surface of the non-magnetic layer on the non-magnetic support side) between the non-magnetic layer and the non-magnetic support, which are specified as described above, is specified as the non-magnetic layer.

### (3) Specification of Void Ratio of Non-Magnetic Layer and Calculation of Void Ratio

The measurement region identified as the non-magnetic layer in (2) above is subjected to a sharpening process, which is a function of the image processing software WinROOF manufactured by Mitani Shoji Co., Ltd., and then is subjected to a noise removal (4 pixels/1280 pixels) process to emphasize an outline of the void present in the measurement region. Then, the outline of the void present in the measurement region is manually selected, and next, the outline and a portion surrounded by the outline are binarized by the image processing software. In this case, a portion where the binarized area is less than 25 nm² is not regarded as a void but is regarded as noise and is excluded from the selection, and a portion where the binarized area is 25 nm² or more is specified as a void. Next, the areas of the portions specified as the voids are summed to obtain the total area of the voids. The void ratio is obtained from the following expression. Avoid ratio of each of the 10 images is obtained, and an arithmetic average thereof is defined as a void ratio of the non-magnetic layer. In the following expression, the unit of the total area of the voids and the unit of the area of the measurement region may be nm², m², or other units as long as the units are the same.

Void ratio (%)=(total area of voids/area of measurement region)×100

Among the voids present in the measurement region, there may be a void of which a part is within the measurement region and the other part is outside the measurement region. For such a void, the area of the portion in the measurement region of the void is used in the calculation of the total area of the void in obtaining the void ratio, and the area of the portion outside the measurement region is not included in the calculation of the total area.

On the other hand, the thickness of the magnetic layer is obtained by the following method.

The sample for observing a cross section manufactured by the method described in (1) above is observed with the SEM, and a cross-sectional image (SEM image) is captured. As the scanning electron microscope, a field emission scanning electron microscope (FE-SEM) is used. For example, FE-SEM S4800 manufactured by Hitachi, Ltd. can be used, and this FE-SEM was used in Examples and Comparative Examples described below.

In the SEM image, ten randomly selected portions of the manufactured sample for observing a cross section are imaged such that the entire thickness direction region of the non-magnetic layer and at least a part of the magnetic layer and at least a part of the non-magnetic support are included in the SEM image. In this way, a total of 10 SEM images are obtained.

Each of the SEM images is secondary electron images (SE images) captured at an acceleration voltage of 5 kV, an imaging magnification of 50000×, and vertical 960 pixels×horizontal 1280 pixels. The interface between the magnetic layer and the non-magnetic layer is specified by the method described in (2) above. The magnetic layer surface is visually specified.

At any one portion on each SEM image, an interval between the interface between the magnetic layer and the non-magnetic layer specified by the above method and the magnetic layer surface in the thickness direction is obtained, and an arithmetic average of values obtained for 10 images is calculated as a thickness of the magnetic layer. Thicknesses of layers other than the magnetic layer and the non-magnetic support can also be obtained by the same method. Alternatively, the thicknesses of the other layers may be obtained as designed thicknesses calculated from the manufacturing conditions.

Incidentally, improving the dispersibility of the non-magnetic powder in the non-magnetic layer may lead to reduction in the void ratio of the non-magnetic layer. In this regard, JP2020-144960A discloses, in a paragraph 0076, that in the non-magnetic layer containing carbon black as the non-magnetic powder, a vinyl chloride resin is a binding agent that contributes to improving the dispersibility of the carbon black. However, in a case where the non-magnetic metal contains a large amount of the vinyl chloride resin, the value of the chlorine content (magnetic layer+non-magnetic layer) of the magnetic recording medium is increased. In addition, in the examples of JP2004-103067A and the examples of JP2005-267714A, the non-magnetic powder of the non-magnetic layer is largely made of an α-iron oxide powder (see paragraph 0081 of JP2004-103067A and paragraph 0085 of JP2005-267714A). However, in a case where the non-magnetic powder of the non-magnetic layer is largely made of the α-iron oxide powder, the value of the iron content (magnetic layer+non-magnetic layer) of the magnetic recording medium is increased. On the other hand, the non-magnetic layer containing the carbon black as described below and the binding agent as described below is preferable in terms of reducing the void ratio of the non-magnetic layer while keeping the chlorine content (magnetic layer+non-magnetic layer) of the magnetic recording medium and the iron content (magnetic layer+non-magnetic layer) of the magnetic recording medium low.

### Non-Magnetic Powder

The non-magnetic layer is a layer containing at least a non-magnetic powder. As the non-magnetic powder contained in the non-magnetic layer, only one kind of non-magnetic powder may be used, or two or more kinds of non-magnetic powders may be used. As the non-magnetic powder, at least carbon black is preferably used, and carbon black having a pH in a range of 7.0 to 10.0 is more preferable. In the present invention and the present specification, the pH of the non-magnetic powder such as carbon black is a value measured according to a standard test method ASTM D1512.

The carbon black generally has a graphite structure which is a condensed polycyclic aromatic structure, and includes π electrons which can move freely in the structure, and the inclusion of the π electrons leads to the expression of good electrical conductivity. Therefore, the carbon black can exhibit the properties as an electron donor, and in a case where the carbon black is dispersed in water, the carbon black selectively adsorbs H⁺ ions among H⁺ ions and OH ions generated by the dissociation of water, and retains OH⁻ ions, which results in a basic pH. This is because carbon black mainly consists of the original graphite structure and retains an abundance of π electrons.

On the other hand, carbon black exhibiting an acidic pH is also commercially available as the carbon black. In the carbon black exhibiting an acidic pH, oxygen is introduced into the structure by oxidation treatment. Oxygen is chemically bonded to carbon (C) to form a functional group exhibiting acidity, such as a hydroxy group and a carboxy group. Such an oxygen-carbon chemical bond reduce the properties of the electron donor and thus the pH decreases, making pH of the carbon black an acidic pH. Therefore, in the carbon black exhibiting an acidic pH, it can be said that the original graphite structure is chemically deteriorated and the condensed polycyclic aromatic structure is reduced.

For the above reasons, the present inventor consideres that carbon black exhibiting a pH in a range of 7.0 to 10.0, which is a neutral to basic pH, has a large number of condensed polycyclic aromatic structures as compared with the carbon black exhibiting an acidic pH. A binding agent that is preferably used in combination with the carbon black exhibiting a pH in a range of 7.0 to 10.0 from the viewpoint of improving the dispersibility will be described below.

The carbon black can be manufactured by, for example, a furnace method in which petroleum-based or coal-based oil is blown into high-temperature gas as a raw material and incompletely burned to obtain carbon black. The carbon black manufactured by the furnace method is called furnace black. In addition, the following carbon black is also known as the carbon black.

Examples thereof include lamp black manufactured by a lamp black method of burning oil, pine, or the like in a shallow dish; acetylene black manufactured by an acetylene black method of thermally decomposing acetylene gas; thermal black manufactured by a thermal black method of thermally decomposing other hydrocarbon gases; and channel black manufactured by a channel black method of partially oxidizing natural gas, aromatic oil, or the like.

As the carbon black exhibiting a pH in a range of 7.0 to 10.0, which is a neutral to basic pH, for example, carbon black selected from the group consisting of furnace black, lamp black, acetylene black, and thermal black can be used. On the other hand, the channel black tends to exhibit an acidic pH. Note that the manufacturing method of the carbon black contained in the non-magnetic metal is not particularly limited.

From the viewpoint of reducing the void ratio of the non-magnetic layer, the specific surface area of the carbon black is preferably 280 m²/g or more and more preferably 300 m²/g or more. From the viewpoint of improving the dispersibility of the carbon black in the non-magnetic layer, the specific surface area of the carbon black is preferably 500 m²/g or less and more preferably 400 m²/g or less. In the present invention and the present specification, a specific surface area of various powders is a specific surface area obtained by using the Brunauer-Emmett-Teller (BET) equation derived by Brunauer, Emmett, and Teller by means of a nitrogen adsorption method according to JIS K 6217-7:2013. Each specific surface area of various powders used in Examples and Comparative Examples, which will be described below, is a specific surface area measured for a raw material powder used in the preparation of a composition for forming each layer. Note that it is also possible to extract a powder from the magnetic recording medium by a well-known method, and obtain a specific surface area of the extracted powder. The same applies to the pH of the powder.

A proportion of the carbon black in the non-magnetic powder of the non-magnetic layer is preferably 50.0% by mass or more, more preferably 60.0% by mass or more, 70.0% by mass or more, 80.0% by mass or more, and 90.0% by mass or more in this order, and still more preferably 100.0% by mass (that is, the non-magnetic powder is only the carbon black) with respect to the total amount of the non-magnetic powder. In addition, a proportion of the carbon black in the non-magnetic powder of the non-magnetic metal may be 100.0% by mass or less, less than 100.0% by mass, less than 99.0% by mass, or less than 95.0% by mass with respect to the total amount of the non-magnetic powder. The content (filling percentage) of the non-magnetic powder of the non-magnetic layer is preferably in a range of 50% to 90% by mass and more preferably in a range of 60% to 90% by mass, with respect to the total mass of the non-magnetic layer.

As a non-magnetic powder other than carbon black, an inorganic powder may be used, or an organic powder may be used. An average particle size of the non-magnetic powder other than the carbon black is preferably in a range of 10 to 200 nm and more preferably in a range of 10 to 100 nm. A specific surface area of the non-magnetic powder other than the carbon black may be, for example, in a range of 60 to 150 m²/g. A pH of the non-magnetic powder other than the carbon black may be, for example, in a range of 7.0 to 10.0.

Examples of the inorganic powder include powders of metal, metal oxide, metal carbonate, metal sulfate, metal nitride, metal carbide, and metal sulfide. The non-magnetic powder can be purchased as a commercially available product or can be manufactured by a well-known method. For details thereof, for example, descriptions disclosed in paragraphs 0146 to 0150 of JP2011-216149A can be referred to. Examples of the non-magnetic powder include an α-iron oxide powder (generally also referred to as “Bengala”). However, in a case where the non-magnetic powder of the non-magnetic layer is largely made of the α-iron oxide powder, the value of the iron content (magnetic layer+non-magnetic layer) of the magnetic recording medium is increased. Therefore, in the non-magnetic layer containing the α-iron oxide powder, a proportion of the α-iron oxide powder in the non-magnetic powder of the non-magnetic layer is preferably less than 50.0% by mass, more preferably 40.0% by mass or less, still more preferably 30.0% by mass or less, 20.0% by mass or less, 10.0% by mass or less, and 5.0% by mass or less in this order, and still more preferably 0.0% by mass (that is, the α-iron oxide powder is not contained) with respect to the total amount of the non-magnetic powder.

### Binding Agent

The magnetic recording medium can be a coating type magnetic recording medium, and can include a binding agent in the non-magnetic layer. The binding agent is one or more resins. In the present invention and the present specification, the resin may be a homopolymer or a copolymer. As the binding agent of the non-magnetic layer, for example, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. An average molecular weight of the resin used as the binding agent of the non-magnetic layer may be, for example, 5,000 or more and 200,000 or less or 10,000 or more and 200,000 or less. Unless otherwise noted, the weight-average molecular weight and number-average molecular weight in the present invention and the present specification are values obtained by performing polystyrene conversion of a value measured by gel permeation chromatography (GPC) under the following measurement conditions. The content of the binding agent may be, for example, 1.0 to 30.0 parts by mass with respect to 100.0 parts by mass of the non-magnetic powder.
GPC device: HLC-8120 (manufactured by Tosoh Corporation)
Column: TSK gel Multipore HXL-M (manufactured by Tosoh Corporation, 7.8 mm inner diameter (ID)×30.0 cm)
Eluent: tetrahydrofuran (THF)

As the binding agent that is preferably used in combination with the carbon black exhibiting a pH in a range of 7.0 to 10.0 from the viewpoint of improving the dispersibility, a polyurethane resin having an aromatic ring structure can be used. The present inventor considers that the polyurethane resin having an aromatic ring structure has high affinity and adsorptivity for carbon black having a pH in a range of 7.0 to 10.0, and thus can contribute to improvement of the dispersibility of the carbon black having a pH in the above range.

Examples of the polyurethane resin include polyurethane resins having various skeletons, such as polyether urethane, polyester urethane, polycarbonate urethane, and polyether ester urethane. The polyurethane resin having an aromatic ring structure can be, for example, a polyurethane resin synthesized using an isocyanate having an aromatic ring structure as an isocyanate compound serving as a raw material for the polyurethane. A urethane group concentration of the polyurethane resin synthesized using the isocyanate having an aromatic ring structure is preferably 1.0 meq/g to 5.0 meq/g and more preferably 1.5 meq/g to 4.5 meq/g. In the above-described polyurethane resin of which the urethane group concentration is 1.0 meq/g or more, and further 1.5 meq/g or more, the aromatic ring skeleton derived from the isocyanate having an aromatic ring structure included in the polyurethane chain is sufficient, and the affinity and the adsorptivity to the carbon black are excellent. In addition, in the above-described polyurethane resin of which the urethane group concentration is 5.0 meq/g or less, and further 4.5 meq/g or less, solubility in a solvent usually used for manufacturing the coating type magnetic recording medium is high, which can also contribute to the improvement of the dispersibility of the carbon black. “eq” is an equivalent and is a unit that cannot be converted into an SI unit.

Examples of the polyol and isocyanate compound used as a raw material of the polyurethane resin include long-chain diols, short-chain diols, and diisocyanate compounds disclosed in “Polyurethane Resin Handbook” (edited by Iwata Keiji, 1986, Nikkan Kogyo Shimbun, Ltd.). The polyurethane chain may be linear, or may have a side chain structure and/or a branched structure.

In order to impart a side chain structure to the polyurethane resin, a compound having a side chain structure and two or more functional groups reacting with isocyanate in one molecule can be used. Examples of the compound having a side chain structure and two or more functional groups reacting with isocyanate in one molecule include 1,2-propylene glycol, 1,3-propylene glycol, 1,3-butylene glycol, 2,3-butylene glycol, 2,2-dimethyl-1,3-propanediol, 3-methyl-1,5-pentanediol, 2,2,4-trimethyl-1,3-pentanediol, 2-ethyl-1,3-hexanediol, 2,2-dimethyl-3-hydroxypropyl-2′,2′-dimethyl-3-hydroxypropionate, 2-normal butyl-2-ethyl-1,3-propanediol, 3-ethyl-1,5-pentanediol, 3-propyl-1,5-pentanediol, 2,2-diethyl-1,3-propanediol, 2-butyl, 2-ethyl-1,3-propanediol, 3-octyl-1,5-pentanediol, 3-phenyl-1,5-pentanediol, 2,5-dimethyl-3-sodium sulfo-2,5-hexanediol, 1,3-bis(hydroxymethyl)cyclohexane, 1,4-bis(hydroxymethyl)cyclohexane, 1,4-bis(hydroxyethyl)cyclohexane, 1,4-bis(hydroxypropyl)cyclohexane, 1,4-bis(hydroxymethoxy)cyclohexane, 1,4-bis(hydroxyethoxy)cyclohexane, 2,2-bis(4-hydroxymethoxycyclohexyl)propane, 2,2-bis(4-hydroxyethoxycyclohexyl)propane, bis(4-hydroxycyclohexyl)methane, 2,2-bis(4-hydroxycyclohexyl)propane, 3(4),8(9)-tricyclo[5.2.1.0^{2,6}]decane dimethanol, hydrogenated bisphenol A, ethylene oxide adduct of hydrogenated bisphenol A, and propylene oxide adduct of hydrogenated bisphenol A. As the compound having a side chain structure and two or more functional groups reacting with isocyanate in one molecule, 2,2-dimethyl-1,3-propanediol, 2,2-dimethyl-3-hydroxypropyl-2′,2′-dimethyl-3-hydroxypropionate, 2-normylbutyl-2-ethyl-1,3-propanediol, 2,2-diethyl-1,3-propanediol, 2-butyl-2-ethyl-1,3-propanediol, 3(4),8(9)-tricyclo[5.2.1.0^{2,6}]decan dimethanol, hydrogenated bisphenol A having an alicyclic skeleton, an ethylene oxide adduct of hydrogenated bisphenol A, and a propylene oxide adduct of hydrogenated bisphenol A are preferable, and hydrogenated bisphenol A having an alicyclic skeleton is more preferable.

In order to impart a branched structure to the polyurethane resin, a small amount of a tri- or higher functional alcohol can be used in addition to the diol compound during the polyurethane polymerization. As the tri- or higher functional alcohol, trimethylolpropane, glycerin, pentaerythritol, or an ethylene oxide adduct or a propylene oxide adduct thereof is preferable.

For example, in a case where the polyurethane resin is a polyester urethane, it is preferable to have the following skeleton.

In a case where the total of the acid component and the glycol component of the polyester polyol is set to 100 mol %, it is preferable that the aromatic dicarboxylic acid is contained in an amount of 20 mol % or more, with the remainder being an aliphatic and/or alicyclic dicarboxylic acid. Furthermore, the polyester polyol is preferably composed of an aliphatic diol component having an alkyl group having one or more carbon atoms in the side chain, in an amount of 50 to 100 mol % of the total diol component. From the viewpoint of improving the dispersibility of the carbon black and improving the running durability of the magnetic recording medium, it is preferable that the aromatic dicarboxylic acid is contained in an amount of 20 mol % or more. In addition, a molar ratio of the dicarboxylic acid/glycol is not limited to 1/1, and it is also preferable that the glycol component is excessive. The preferred range thereof is 1/1 to 1/2.5.

Examples of the aromatic dicarboxylic acid include terephthalic acid, isophthalic acid, orthophthalic acid, and naphthalenedicarboxylic acid. Among these, from the viewpoint of both the dispersibility of the carbon black and the running durability of the magnetic recording medium, isophthalic acid and orthophthalic acid are preferable.

Examples of the aliphatic diol component having an alkyl group having one or more carbon atoms in a side chain include 1,2-propylene glycol, 1,3-butylene glycol, 2,3-butylene glycol, 2-methyl-1,3-propanediol, 2,2-dimethyl-1,3-propanediol, 3-methyl-1,5-pentanediol, 2,2-dimethyl-3-hydroxypropyl-2′,2′-dimethyl-3-hydroxypropionate, 2-butyl, 2-ethyl-1,3-propanediol, and 2,2-diethyl-1,3-propanediol. Among these, 2,2-dimethyl-1,3-propanediol, 2,2-diethyl-1,3-propanediol, 2-butyl, 2-ethyl-1,3-propanediol, and 2,2-dimethyl-3-hydroxypropyl-2′,2′-dimethyl-3-hydroxypropionate are preferable.

Examples of other diol components used in the polyester polyol include aliphatic glycols such as ethylene glycol, 1,3-propanediol, 1,4-butanediol, 1,5-pentanediol, and 1,6-hexanediol, and alicyclic glycols such as 1,3-bis(hydroxymethyl)cyclohexane, 1,4-bis(hydroxymethyl)cyclohexane, 1,4-bis(hydroxyethyl)cyclohexane, 1,4-bis(hydroxypropyl)cyclohexane, 1,4-bis(hydroxymethoxy)cyclohexane, 1,4-bis(hydroxyethoxy)cyclohexane, 2,2-bis(4-hydroxymethoxycyclohexyl)propane, 2,2-bis(4-hydroxyethoxycyclohexyl)propane, bis(4-hydroxycyclohexyl)methane, 2,2-bis(4-hydroxycyclohexyl)propane, and 3(4),8(9)-tricyclo[5.2.1.0^{2,6}]decane dimethanol. Among these, 1,3-propanediol, 1,4-bis(hydroxymethyl)cyclohexane, and 3(4),8(9)-tricyclo[5.2.1.0^{2,6}]decane dimethanol are preferable.

From the viewpoint of obtaining a polyurethane resin having high solubility in a solvent usually used for manufacturing the coating type magnetic recording medium, it is preferable that the above-described polyester polyol has a number-average molecular weight of 300 to 800, which is a number-average molecular weight calculated from a hydroxyl number measured by the method disclosed in JIS standard K1557-1:2007.

Examples of the aromatic isocyanate used in the synthesis of the polyurethane resin include 2,4-tolylene diisocyanate, 2,6-tolylene diisocyanate, p-phenylene diisocyanate, 4,4′-diphenylmethane diisocyanate, m-phenylene diisocyanate, 3,3′-dimethoxy-4,4′-biphenylene diisocyanate, 2,6-naphthalene diisocyanate, 3,3′-dimethyl-4,4′-biphenylene diisocyanate, 4,4′-diphenylene diisocyanate, 4,4′-diisocyanate diphenyl ether, 1,5-naphthalene diisocyanate, and m-xylene diisocyanate. Among these, 4,4′-diphenylmethane diisocyanate is more preferable.

For the short-chain diol component used in the synthesis of the polyurethane resin, the above-described description regarding the other diol components used in the polyester polyol and the above-described description regarding the compound having a side chain structure and two or more functional groups reacting with isocyanate in one molecule can be referred to. Specific examples of the short-chain diol can also include the short-chain diol used in synthesis of a polyurethane resin A described below. In the synthesis of the polyurethane resin, the use of the short-chain diol having a side chain structure is preferable from the viewpoint of improving the solvent solubility of a unit in which the short-chain diol and the aromatic isocyanate are bonded to each other.

From the viewpoint of improving the dispersibility of the carbon black having a pH in a range of 7.0 to 10.0, the polyurethane resin preferably contains a sulfonic acid metal base in the skeleton. The sulfonic acid metal base acts to be adsorbed on a basic site on the surface of the carbon black. From the viewpoint of improving the dispersibility of the carbon black exhibiting a pH in the above range and improving the solvent solubility of the polyurethane resin, the content of the sulfonic acid metal base in the polyurethane resin is preferably in a range of 60 to 400 eq/ton. Examples of the method for introducing the metal sulfonate salt salt group into the polyurethane resin include a method of copolymerizing 5-Na sulfoisophthalic acid or 5-K sulfoisophthalic acid in the polyester polyol or using a diol containing a sulfonic acid metal base.

The number-average molecular weight of the polyurethane resin is preferably in a range of 5,000 to 100,000, and more preferably in a range of 10,000 to 80,000. As a method for synthesizing the polyurethane resin, either a method of synthesizing the raw material in a molten state or a method of performing the synthesis by dissolving the raw material in a solution may be used. As a reaction catalyst, octyl acid first tin, dibutyltin dilaurate, triethylamine, or the like can be used. In addition, an ultraviolet absorbent, a hydrolysis inhibitor, an antioxidant, or the like may be added before, during, or after the manufacture of the polyurethane resin.

The content of the polyurethane resin having an aromatic ring structure is preferably 50.0% by mass or more, more preferably 60.0% by mass or more, 70.0% by mass or more, 80.0% by mass or more, 90.0% by mass or more, and 95.0% by mass or more in this order, and still more preferably 100.0% by mass (that is, the binding agent of the non-magnetic layer is only the polyurethane resin having an aromatic ring structure) with respect to the total amount of the binding agent of the non-magnetic layer.

As the binding agent of the non-magnetic layer, one or more kinds of the polyurethane resin having an aromatic ring structure may be used alone, or one or more kinds of the polyurethane resin having an aromatic ring structure and one or more kinds of resins other than the polyurethane resin having an aromatic ring structure may be used. Since the vinyl chloride resin can increase the value of the chlorine content (magnetic layer+non-magnetic layer) of the magnetic recording medium, in a case where the binding agent of the non-magnetic layer contains the vinyl chloride resin, the content of the vinyl chloride resin is preferably 50.0% by mass or less, more preferably 40.0% by mass or less, 30.0% by mass or less, 20.0% by mass or less, 10.0% by mass or less, and 5.0% by mass or less in this order, and still more preferably 0.0% by mass (that is, the vinyl chloride resin is not contained) being still more preferable with respect to the total amount of the binding agent of the non-magnetic layer.

For the non-magnetic layer, one or more kinds of other well-known additives can be used in any amount by being appropriately selected from commercially available products according to desired properties, or by being produced using a well-known method. For the additive which can be contained in the non-magnetic layer, the following description can also be referred to.

The non-magnetic layer of the present invention and the present specification also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 100 Oe, or a layer having a residual magnetic flux density equal to or smaller than 10 mT and a coercivity equal to or smaller than 100 Oe. Regarding the unit Oe, 1 [kOe]=10⁶/4π [A/m]. It is preferable that the non-magnetic layer does not have a residual magnetic flux density and coercivity.

### Magnetic Layer

### Ferromagnetic Powder

As a ferromagnetic powder contained in the magnetic layer, a well-known ferromagnetic powder as a ferromagnetic powder used in magnetic layers of various magnetic recording media can be used. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of magnetization stability, the average particle size of the ferromagnetic powder is preferably 5 nm or more, more preferably 8 nm or more, still more preferably 10 nm or more, and still preferably 15 nm or more.

### Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in an X-ray diffraction spectrum obtained by X-ray diffraction analysis, it is determined that the hexagonal ferrite crystal structure is detected as the main phase. In a case where only a single structure is detected by X-ray diffraction analysis, this detected structure is taken as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), an europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is one aspect of the hexagonal ferrite powder, will be described in more detail.

An activation volume of the hexagonal strontium ferrite powder is preferably in a range of 800 to 1500 nm³. The finely granulated hexagonal strontium ferrite powder having an activation volume in the above range is suitable for manufacturing a magnetic recording medium exhibiting excellent electromagnetic conversion characteristics. The activation volume of the hexagonal strontium ferrite powder is preferably 800 nm³ or more, and may be, for example, 850 nm³ or more. From the viewpoint of further improving the electromagnetic conversion characteristics, the activation volume of the hexagonal strontium ferrite powder is more preferably 1400 nm³ or less, still more preferably 1300 nm³ or less, still more preferably 1200 nm³ or less, and still more preferably 1100 nm³ or less. An activation volume of the hexagonal barium ferrite powder is also preferably within the above-described range.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity He and an activation volume V, by performing measurement in a coercivity He measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

$$Hc = 2 Ku / Ms \{ 1 - {[ ( kT / KuV ) ln ( At / 0.693 ) ]}^{1 / 2} \}$$

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content>1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content>1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

It is speculated that the use of the hexagonal strontium ferrite powder having the rare earth atom surface layer portion uneven distribution property as the ferromagnetic powder of the magnetic layer contributes to the prevention of scraping of the magnetic layer surface due to the sliding on the magnetic head. That is, it is speculated that the hexagonal strontium ferrite powder having the rare earth atom surface layer portion uneven distribution property can also contribute to the improvement of running durability of the magnetic recording medium. It is speculated that this may be because uneven distribution of rare earth atoms on a surface of a particle constituting the hexagonal strontium ferrite powder contributes to an improvement of interaction between the particle surface and an organic substance (for example, a binding agent and/or an additive) contained in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic recording medium, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10% to 20% by mass of the particle constituting the hexagonal strontium ferrite powder with the total particle being 100% by mass. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 ml of 1 mol/L hydrochloric acid is held on a hot plate at a set temperature of 70° C. for 1 hour. The obtained solution is filtered by a membrane filter of 0.1 m. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 ml of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic recording medium, it is desirable that mass magnetization as of the ferromagnetic powder included in the magnetic recording medium is high. In this regard, the hexagonal strontium ferrite powder including a rare earth atom but not having the rare earth atom surface layer portion uneven distribution property tends to have a larger decrease in as than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in as. In one aspect, as of the hexagonal strontium ferrite powder maybe 45 A·m²/kg or more, and may be 47 A·m²/kg or more. On the other hand, from the viewpoint of noise reduction, as is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization as is a value measured at a magnetic field intensity of 15 kOe.

Regarding the content (bulk content) of a constituent atom of the hexagonal strontium ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M type hexagonal ferrite is represented by a composition formula of AFe₁₂O₁₉. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: % by mass) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0% by mass. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

### Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

### ε-Iron Oxide Powder

Preferred specific examples of the ferromagnetic powder include an F-iron oxide powder. In the present invention and the present specification, the term “F-iron oxide powder” refers to a ferromagnetic powder in which an F-iron oxide crystal structure is detected as a main phase by X-ray diffraction analysis. For example, in a case where the highest intensity diffraction peak is attributed to an F-iron oxide crystal structure in an X-ray diffraction spectrum obtained by X-ray diffraction analysis, it is determined that the F-iron oxide crystal structure is detected as the main phase. As a method of manufacturing an F-iron oxide powder, a manufacturing method from a goethite, a reverse micelle method, and the like are known. All of the manufacturing methods are well known. Regarding a method of manufacturing an F-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Note that the method of manufacturing the F-iron oxide powder capable of being used as the ferromagnetic powder in the magnetic layer of the magnetic recording medium is not limited to the methods described here.

An activation volume of the F-iron oxide powder is preferably in a range of 300 to 1500 nm³. The finely granulated F-iron oxide powder having an activation volume in the above range is suitable for manufacturing a magnetic recording medium exhibiting excellent electromagnetic conversion characteristics. The activation volume of the F-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The F-iron oxide powder preferably has Ku of 3.0×10⁴ J/m³ or more, and more preferably has Ku of 8.0×10⁴ J/m³ or more. Ku of the F-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic recording medium, it is desirable that mass magnetization as of the ferromagnetic powder included in the magnetic recording medium is high. In this regard, in one aspect, as of the F-iron oxide powder may be 8 A·m²/kg or more, and may be 12 A·m²/kg or more. On the other hand, from the viewpoint of noise reduction, as of the F-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000× with a transmission electron microscope, the image is printed on photographic printing paper or displayed on a display so that the total magnification of 500000× to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in the section of Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic recording medium in order to measure the particle size, a method disclosed in a paragraph 0015 of JP2011-048878A can be employed, for example.

In the present invention and the present specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50% to 90% by mass and more preferably in a range of 60% to 90% by mass, with respect to the total mass of the magnetic layer. A high filling percentage of the ferromagnetic powder in the magnetic layer is preferable from the viewpoint of improving the recording density.

### Non-Magnetic Powder

The magnetic recording medium may contain one or more kinds of non-magnetic powders in the magnetic layer. It is preferable that the non-magnetic powder includes at least a non-magnetic powder that contributes to formation of a protrusion on the magnetic layer surface (hereinafter, referred to as a “protrusion forming agent”). In addition, it is also preferable that the magnetic layer contains, as the non-magnetic powder, a non-magnetic powder (hereinafter, referred to as an “abrasive”) which can function as an abrasive. Hereinafter, the protrusion forming agent and the abrasive will be further described.

### Protrusion Forming Agent

The protrusion forming agent may be an inorganic powder or an organic powder. Examples of the inorganic powder include powders of an inorganic oxide such as a metal oxide, metal carbonate, metal sulfate, a metal nitride, a metal carbide, a metal sulfide, and the like, and a powder of an inorganic oxide is preferable. An average particle size of the protrusion forming agent is, for example, preferably in a range of 90 to 200 nm, and more preferably in a range of 100 to 150 nm. In one aspect, from the viewpoint of uniformization of the friction characteristics, a particle size distribution of the protrusion forming agent is preferably monodispersion showing a single peak, rather than polydispersion having a plurality of peaks in a particle size distribution. From the viewpoint of ease of obtaining the monodispersed particles, the protrusion forming agent is preferably an inorganic powder and more preferably a colloid particle. The term “colloidal particles” in the present invention and the present specification refers to particles which are dispersed without precipitation to generate a colloidal dispersion, in a case where 1 g of the particles per 100 mL of the organic solvent is added to at least one organic solvent of methyl ethyl ketone, cyclohexanone, toluene, or ethyl acetate, or a mixed solvent including two or more kinds of the solvent described above at an optional mixing ratio. The fact in which the non-magnetic powder contained in the magnetic layer is colloidal particles may be confirmed by evaluating whether or not the non-magnetic powder has properties which meet the aforementioned definition of the colloidal particles in a case where the non-magnetic powder used for forming the magnetic layer is available. Alternatively, the fact can be confirmed by evaluating whether or not the non-magnetic powder extracted from the magnetic layer has properties which meet the aforementioned definition of the colloidal particles.

As specific examples of the colloidal particles, colloidal particles of an inorganic oxide such as SiO₂, Al₂O₃, TiO₂, ZrO₂, and Fe₂O₃ can be mentioned, and colloidal particles of a composite inorganic oxide such as SiO₂ Al₂O₃, SiO₂ B₂O₃, TiO₂ CeO₂, SnO₂ Sb₂O₃, SiO₂ Al₂O₃ TiO₂, and TiO₂ CeO₂ SiO₂ can also be mentioned. Moreover, regarding the notation of the composite inorganic oxide, “⋅” is used to indicate that the compound is a composite inorganic oxide of the inorganic oxides described before and after “⋅”. For example, SiO₂ Al₂O₃ means a composite inorganic oxide of SiO₂ and Al₂O₃. As the colloidal particles, colloidal particles of silicon dioxide (silica), that is, silica colloidal particles (also referred to as “colloidal silica”) are particularly preferable. Furthermore, regarding the colloidal particles, the descriptions disclosed in paragraphs 0048 and 0049 of JP2017-68884A can also be referred to.

A content of the protrusion forming agent in the magnetic layer is preferably 0.1 to 10.0 parts by mass, more preferably 0.1 to 5.0 parts by mass, and still more preferably 1.0 to 5.0 parts by mass with respect to 100.0 parts by mass of the ferromagnetic powder. In the present invention and the present specification, a certain component may be used alone or in combination of two or more kinds thereof. In a case of using two or more kinds, the content refers to the total content of two or more kinds.

### Abrasive

The abrasive is a component capable of exhibiting the ability (abrasive properties) to remove attached substances attached to a magnetic head during running. Examples of the abrasive include powders of alumina (Al₂O₃), silicon carbide, boron carbide (B₄C), TiC chromium oxide (Cr₂O₃), cerium oxide, zirconium oxide (ZrO₂), iron oxide, and diamond that are materials normally used as the abrasive of the magnetic layer. The powders of alumina such as α-alumina, silicon carbide, and diamond are preferable among the above. A content of the abrasive in the magnetic layer is preferably 1.0 to 20.0 parts by mass, more preferably 3.0 to 15.0 parts by mass, and even more preferably 4.0 to 10.0 parts by mass, with respect to 100.0 parts by mass of the ferromagnetic powder. In addition, regarding a particle size of the abrasive, a specific surface area, which is an index of the particle size, may be, for example, 14 m²/g or more, preferably 16 m²/g or more, and more preferably 18 m²/g or more. In addition, the specific surface area of the abrasive may be, for example, 40 m²/g or less.

### Binding Agent and Curing Agent

The magnetic recording medium can include a binding agent in the magnetic layer. As the binding agent of the magnetic layer, various resins usually used as a binding agent of a coating type magnetic recording medium can be used. For example, as the binding agent of the magnetic layer, for example, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. For the above binding agent, descriptions disclosed in paragraphs 0028 to 0031 of JP2010-24113A can be referred to. An average molecular weight of the resin used as the binding agent of the magnetic layer can be, for example, 10,000 or more and 200,000 or less as a weight-average molecular weight. The content of the binding agent of the magnetic layer can be, for example, 1.0 to 30.0 parts by mass with respect to 100.0 parts by mass of the ferromagnetic powder.

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. The curing reaction proceeds in a magnetic layer forming step, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The curing agent can be used in an amount of, for example, 0 to 80.0 parts by mass, and preferably 50.0 to 80.0 parts by mass from the viewpoint of improving a strength of the magnetic layer, with respect to 100.0 parts by mass of the binding agent.

### Additive

The magnetic layer may further include one or more kinds of additives, as necessary. As the additives, the curing agent described above is used as an example. In addition, examples of the additive which can be included in the magnetic layer include a lubricant, a dispersing agent, a dispersing assistant, a fungicide, an antistatic agent, and an antioxidant. As the additive, a commercially available product can be appropriately selected or manufactured by a well-known method according to the desired properties, and any amount thereof can be used. For example, for the lubricant, descriptions disclosed in paragraphs 0030 to 0033, 0035, and 0036 of JP2016-126817A can be referred to. The non-magnetic layer which will be described below may contain a lubricant. For the lubricant that can be contained in the non-magnetic layer, descriptions disclosed in paragraphs 0030, 0031, 0034, 0035, and 0036 of JP2016-126817A can be referred to. For the dispersing agent, descriptions disclosed in paragraphs 0061 and 0071 of JP2012-133837A can be referred to. The dispersing agent may be added to a composition for forming a non-magnetic layer. For the dispersing agent that can be added to the composition for forming a non-magnetic layer, a description disclosed in a paragraph 0061 of JP2012-133837A can be referred to. Examples of the additive that can be used to improve the dispersibility of the abrasive in the magnetic layer containing the abrasive include a dispersing agent disclosed in paragraphs 0012 to 0022 of JP2013-131285A.

### Non-Magnetic Support

Next, the non-magnetic support (hereinafter, referred to as a “support”) will be described. As the non-magnetic support, well-known components such as polyethylene terephthalate, polyethylene naphthalate, polyamide, polyamide imide, and aromatic polyamide subjected to biaxial stretching are used. Among these, polyethylene terephthalate, polyethylene naphthalate, and polyamide are preferable. A corona discharge, a plasma treatment, an easy-bonding treatment, or a heat treatment may be performed on these supports in advance.

### Back Coating Layer

The magnetic recording medium may include a back coating layer containing a non-magnetic powder on a surface side of the non-magnetic support opposite to the surface side having the magnetic layer and the non-magnetic layer. Alternatively, the magnetic recording medium may be a magnetic recording medium having no back coating layer. The back coating layer preferably contains any one or both of carbon black and an inorganic powder. For details of the back coating layer, well-known technologies for the back coating layer can be applied. In addition, the back coating layer may contain a binding agent. Regarding the binding agent contained in the back coating layer and various additives which may be optionally contained in the back coating layer, the above-mentioned well-known technologies for the formulation of the magnetic layer and/or the non-magnetic layer can be optionally applied. For example, for the back coating layer, descriptions disclosed in paragraphs 0018 to 0020 of JP2006-331625A and page 4, line 65, to page 5, line 38, of U.S. Pat. No. 7,029,774B can be referred to.

### Manufacturing Step

### Preparation of Composition for Forming Each Layer

A composition for forming the magnetic layer, the non-magnetic layer, or the back coating layer usually includes a solvent together with the various components described above. As a solvent, one kind or two or more kinds of various solvents generally used for manufacturing a coating type magnetic recording medium can be used. A solvent content of the composition for forming each layer is not particularly limited. For the solvent, a description disclosed in a paragraph 0153 of JP2011-216149A can be referred to. The concentration of solid contents and the solvent composition of the composition for forming each layer need only be appropriately adjusted in accordance with the handling suitability of the composition, the coating conditions, and the thickness of each layer to be formed. A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. A centrifugal separation treatment for a dispersion liquid of the protrusion forming agent is as described above. All raw materials used in the preparation of the composition for forming each layer may be added at the beginning or during any step. In addition, each raw material may be separately added in two or more steps. For example, the binding agent may be dividedly added in a kneading step, a dispersing step, and a mixing step for adjusting a viscosity after dispersion. In the manufacturing step of the magnetic recording medium, a well-known manufacturing technology in the related art can be used in a part of the steps. In the kneading step, an open kneader, it is preferable to use a continuous kneader, a pressure kneader, or a kneader having a strong kneading force such as an extruder. Details of the kneading step are described in JP1989-106338A(JP-H01-106338A) and JP1989-79274A(JP-H01-79274A). As a dispersing device, various well-known dispersers using a shearing force, such as a beads mill, a ball mill, a sand mill, or a homomixer, can be used. Dispersion beads can be preferably used for the dispersion. Examples of the dispersion beads include ceramic beads and glass beads, and zirconia beads are preferable. Two or more kinds of beads may be used in combination. A bead diameter (particle size) and a bead filling rate of the dispersion beads are not particularly limited and need only be set depending on a powder to be dispersed. The composition for forming each layer may be filtered by a well-known method before performing the coating step. The filtering can be performed by using a filter, for example. As the filter used in the filtering, a filter having a pore diameter of 0.01 to 3 m (for example, filter made of glass fiber or filter made of polypropylene) can be used, for example.

### Coating Step

The non-magnetic layer and the magnetic layer can be formed by sequentially or simultaneously applying the composition for forming a non-magnetic layer and the composition for forming a magnetic layer in multiple layers. The back coating layer can be formed by applying a composition for forming a back coating layer forming onto a surface of the non-magnetic support opposite to a surface having the non-magnetic layer and/or the magnetic layer (or to be provided with the non-magnetic layer and the magnetic layer). For details of the coating for forming each layer, a description disclosed in a paragraph 0066 of JP2010-231843A can be referred to.

### Other Steps

Regarding various other steps for manufacturing the magnetic recording medium, the descriptions disclosed in paragraphs 0067 to 0070 of JP2010-231843A can be referred to, for example. For example, regarding an alignment treatment, while a coating layer formed of the composition for forming a magnetic layer is in a wet state, the coating layer can be subjected to an alignment treatment in an alignment zone. For the alignment treatment, the various well-known technologies including a description disclosed in a paragraph 0052 of JP2010-24113A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. Further, the coating layer may be preliminarily dried before the transportation to the alignment zone. As an example, a magnetic field strength in the vertical alignment treatment can be 0.10 to 0.80 T or 0.10 to 0.60 T. In addition, a calender treatment can be performed as a treatment for improving surface smoothness of the magnetic recording medium. Regarding conditions for the calender treatment, for example, the calender pressure (linear pressure) can be 200 to 500 kN/m and is preferably 250 to 350 kN/m. A calender temperature (surface temperature of a calender roll) can be, for example, 70° C. to 120° C. and is preferably 80° C. to 100° C., and a calender speed can be, for example, 50 to 300 m/min and is preferably 50 to 200 m/min.

The magnetic recording medium according to one aspect of the present invention may be a tape-shaped magnetic recording medium (magnetic tape) or a disk-shaped magnetic recording medium (magnetic disk). For example, the magnetic tape is usually accommodated in a magnetic tape cartridge and the magnetic tape cartridge is mounted on a magnetic recording and reproducing device. A servo pattern can also be formed on the magnetic recording medium by a well-known method in order to enable head tracking in the magnetic recording and reproducing device. The term “formation of servo pattern” can also be referred to as “recording of servo signal”. Hereinafter, the formation of the servo patterns will be described using a magnetic tape as an example.

The servo pattern is usually formed along a longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape conforming to a linear tape-open (LTO) specification (generally called “LTO tape”) employs a timing-based servo system. In this timing-based servo system, the servo pattern is formed by continuously arranging a plurality of pairs of non-parallel magnetic stripes (also referred to as “servo stripes”) in the longitudinal direction of the magnetic tape. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo signal continuous in the longitudinal direction of the magnetic tape. A plurality of the servo bands are usually provided on the magnetic tape. For example, in an LTO tape, the number of the servo bands is five. Regions interposed between two adjacent servo bands are referred to as data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

In a method of uniquely specifying the servo band, a staggered method as shown in ECMA-319 (June 2001) is used. In this staggered method, a group of pairs of non-parallel magnetic stripes (servo stripes) arranged continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code maybe recorded by thinning out a predetermined pair from the group of pairs of servo stripes.

A head for forming a servo pattern is called a servo write head. The servo write head has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 m or less, 1 to 10 m, 10 m or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

The magnetic tape is usually accommodated in a magnetic tape cartridge and the magnetic tape cartridge is mounted on a magnetic recording and reproducing device.

### Magnetic Tape Cartridge

Another aspect of the present invention relates to a magnetic tape cartridge including the tape-shaped magnetic recording medium (that is, the magnetic tape).

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing device for recording and/or reproducing data on the magnetic tape, the magnetic tape is pulled out of the magnetic tape cartridge to be wound around the reel on the magnetic recording and reproducing device side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing device side. During this time, data is recorded and/or reproduced as the magnetic head and the surface on the magnetic layer side of the magnetic tape come into contact with each other to be slid on each other. With respect to this, in the dual reel type magnetic tape cartridge, both reels of the supply reel and the winding reel are provided in the magnetic tape cartridge. The magnetic tape cartridge may be any of single reel type magnetic tape cartridge or dual reel type magnetic tape cartridge. The above magnetic tape cartridge need only include the magnetic tape according to one aspect of the present invention, and the well-known technology can be applied to the others.

### Magnetic Recording and Reproducing Device

Still another aspect of the present invention relates to a magnetic recording and reproducing device including the magnetic recording medium.

In the present invention and the present specification, the term “magnetic recording and reproducing device” means a device capable of performing at least one of the recording of data on the magnetic recording medium or the reproducing of data recorded on the magnetic recording medium. Such a device is generally called a drive. The magnetic recording and reproducing device can be, for example, a sliding type magnetic recording and reproducing device. The sliding type magnetic recording and reproducing device is a device in which the surface on the magnetic layer side and the magnetic head come into contact with each other to be slid on each other, in a case of performing recording of data on the magnetic recording medium and/or reproducing of the recorded data. For example, the magnetic recording and reproducing device can attachably and detachably include the magnetic tape cartridge.

The magnetic recording and reproducing device may include a magnetic head. The magnetic head can be a recording head capable of performing the recording of data on the magnetic recording medium, and can also be a reproducing head capable of performing the reproducing of data recorded on the magnetic recording medium. In addition, in one aspect, the magnetic recording and reproducing device can include both a recording head and a reproducing head as separate magnetic heads. In another aspect, the magnetic head included in the magnetic recording and reproducing device can have a configuration in which both an element for recording data (recording element) and an element for reproducing data (reproducing element) are included in one magnetic head. Hereinafter, the element for recording data and the element for reproducing are collectively referred to as “elements for data”. As the reproducing head, a magnetic head (MR head) including a magnetoresistive (MR) element capable of sensitively reading data recorded on the magnetic recording medium as a reproducing element is preferable. As the MR head, various well-known MR heads such as an Anisotropic Magnetoresistive (AMR) head, a Giant Magnetoresistive (GMR) head, or a Tunnel Magnetoresistive (TMR) head can be used. In addition, the magnetic head which performs the recording of data and/or the reproducing of data may include a servo signal reading element. Alternatively, as a head other than the magnetic head which performs the recording of data and/or the reproduction of data, a magnetic head (servo head) comprising a servo signal reading element may be included in the magnetic recording and reproducing device. For example, a magnetic head that records data and/or reproduces recorded data (hereinafter also referred to as “recording and reproducing head”) can include two servo signal reading elements, and the two servo signal reading elements can simultaneously read two adjacent servo bands. One or a plurality of elements for data can be disposed between the two servo signal reading elements.

In the magnetic recording and reproducing device, recording of data on the magnetic recording medium and/or reproducing of data recorded on the magnetic recording medium can be performed as the surface of the magnetic recording medium on the magnetic layer side and the magnetic head come into contact with each other to be slid on each other. The magnetic recording and reproducing device need only include the magnetic recording medium according to one aspect of the present invention, and a well-known technology can be applied to the others.

For example, in a case of recording data and/or reproducing recorded data, first, tracking using the servo signal is performed. That is, by causing the servo signal reading element to follow a predetermined servo track, the element for data is controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

### EXAMPLES

Hereinafter, the present invention will be described based on Examples. Note that the present invention is not limited to the embodiments shown in Examples. “Parts” and “%” described below are based on mass. The steps and evaluations in the following description were performed in an environment of an atmosphere temperature of 23° C.±1° C., unless otherwise noted.

In Examples and Comparative Examples, a polyurethane resin A used for preparing the composition for forming a non-magnetic layer was a polyurethane resin having an aromatic cyclic structure, which was synthesized by the following method.

### Synthesis of Polyurethane Resin a Having Aromatic Ring Structure

The polyester polyol (a) shown in Table 2 and a compound (b) which is an EO (ethylene oxide) adduct of HPN (2,2-dimethyl-1,3-propanediol mono (hydroxypivalate)) and Na sulfoisophthalic acid as a short-chain diol were dissolved in a 30% solution of cyclohexanone at a liquid temperature of 60° C. under a nitrogen stream in a container equipped with a reflux condenser and a stirrer and previously substituted with nitrogen. Next, 60 ppm (based on mass) of dibutyltin dilaurate as a catalyst was added thereto and dissolved for further 15 minutes. Further, MDI (4,4′-diphenylmethane diisocyanate) was added as a diisocyanate, and the mixture was heated at a liquid temperature of 90° C. for 6 hours to perform a reaction, thereby obtaining a polyurethane resin A. Raw material compositional ratios were set to values shown in Table

TABLE 1

| | Raw material and | |
|---|---|---|
| | compositional ratio | Unit: % by mass^{Note)} |
| Polyol | Polyester polyol (a) | 100 |
| Short-chain diol | HPN | 30 |
| | Compound (b) | 6 |
| Diisocyanate | MDI | 103.3 |

^{Note)}Amount of polyester polyol (a) is used as reference (100% by mass).
HPN (2,2-dimethyl-1,3-propanediol mono (hydroxypivalate)) 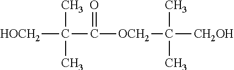
Compound (b) 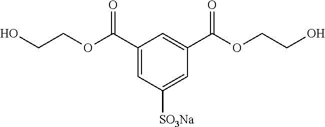
MDI (4,4′-diphenylmethane diisocyanate)

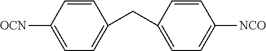

TABLE 2

| | Raw material and compositional | | | | |
|---|---|---|---|---|---|
| | ratio Unit: mol %^{Note)} | | | | Number-average |
| | Dicarboxylic acid | | Diol | | molecular weight |
| Polyester | Adipic acid | 50 | NPG | 100 | 400 |
| polyol (a) | Isophthalic | 50 | (neopentyl | | |
| | Acid | | glycol) | | |

^{Note)}Amount of NPG is used as reference (100 mol %).

The number-average molecular weight of the polyester polyol (a) shown in Table 2 is a value calculated from the hydroxyl number measured by the method disclosed in JIS standard K1557-1:2007.

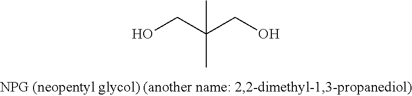

The weight-average molecular weight of the polyurethane resin A, which was obtained by the method described above, was 67,000.

For the polyurethane resin A, the content of the sulfonic acid metal base (SO₃Na) was calculated from the Na concentration, which is a metal component, according to the following formula, and was found to be 70 eq/ton. In the following expression, “23” is the Na atomic weight. The Na concentration (unit: ppm (based on mass)) was obtained by carbonizing 0.1 g of a sample, dissolving the carbonized sample in an acid, and then subjecting the solution to atomic absorption analysis.

Content of sulfonic acid metal base (SO₃Na) (eq/ton)=Na concentration (ppm)/23

For the polyurethane resin A, ¹H-NMR analysis was performed using a nuclear magnetic resonance (NMR) Gemini-200 manufactured by Varian, Inc. in a chloroform-d solvent, and the polyurethane composition was determined by an integral ratio thereof. The urethane group concentration was obtained from mol % of isocyanate obtained by ¹H-NMR analysis by the following expression. The obtained urethane group concentration was 3.5 meq/g.

Urethane group concentration (meq/g)=10³×{2 ×mol % of isocyanate×(1/100)}/(unit molecular weight of polyurethane)

### Example 1

### Formulation of Composition for Forming Magnetic Layer

### Magnetic Liquid

Hexagonal barium ferrite powder: 100.0 parts
   Average particle size: 17 nm, activation volume: 1300 nm³
Oleic acid: 1.5 parts
Vinyl chloride resin: 10.0 parts
   MR-104 manufactured by Kaneka Corporation
Polyurethane resin: 4.0 parts
   UR-4800 manufactured by TOYOBO Co., Ltd. (sulfonic acid-containing polyester polyurethane resin)
Methyl ethyl ketone: 300.0 parts
Cyclohexanone: 300.0 parts
Abrasive Solution
Alumina powder (α-alumina having a specific surface area of 19 m²/g): 9.0 parts
Vinyl chloride resin: 0.7 parts
   MR-110 manufactured by Kaneka Corporation
Cyclohexanone: 20.0 parts

### Protrusion Forming Agent Liquid

Silica colloidal particles (colloidal silica) (average particle size: 150 nm): 2.0 parts
Methyl ethyl ketone: 8.0 parts

### Other Components

Stearic acid: 1.0 part
Stearic acid amide: 0.3 parts
Butyl stearate: 1.5 parts
Methyl ethyl ketone: 110.0 parts
Cyclohexanone: 110.0 parts
Polyisocyanate (CORONATE L produced by Tosoh Corporation): 2.5 parts

### Formulation of Composition for Forming Non-Magnetic Layer

Carbon black: see Table 3
   Specific surface area: see Table 3, pH: see Table 3
Oleic acid: 4.0 parts
Polyurethane resin A: see Table 3
Methyl ethyl ketone: 510.0 parts
Cyclohexanone: 200.0 parts
Stearic acid: 1.5 parts
Stearic acid amide: 0.3 parts
Butyl stearate: 1.5 parts

### Formulation of Composition for Forming Back Coating Layer

Carbon black: 100.0 parts
   Average particle size: 40 nm, dibutyl phthalate (DBP) oil absorption volume: 74 cm³/100 g
Copper phthalocyanine: 3.0 parts
Nitrocellulose: 25.0 parts
Polyurethane resin: 60.0 parts
   UR-8401 manufactured by TOYOBO Co., Ltd. (sulfonic acid-containing polyester polyurethane resin)
Polyester resin: 4.0 parts
   VYLON 500 manufactured by TOYOBO Co., Ltd.
Alumina powder (α-alumina having a specific surface area of 17 m²/g): 1.0 part
Polyisocyanate: 15.0 parts
   CORONATE L manufactured by Tosoh Corporation
Methyl ethyl ketone: 600.0 parts
Toluene: 600.0 parts

### Preparation of Composition for Forming Each Layer

The composition for forming a magnetic layer was prepared as follows.

The components of the magnetic liquid were kneaded and diluted by an open kneader, and then subjected to a dispersion treatment of 30 passes, with a horizontal beads mill dispersing device using zirconia (ZrO₂) beads (hereinafter, referred to as “Zr beads”) having a particle diameter of 0.1 mm, by setting a retention time per pass to 2 minutes at a bead filling rate of 80 vol % and a circumferential speed of a rotor distal end of 10 m/sec.

For the abrasive solution, a mixture of the components (alumina powder, vinyl chloride resin, cyclohexanone) of the aforementioned abrasive solution was prepared, then the mixture was put in a horizontal beads mill dispersing device together with Zr beads having a particle diameter of 0.3 mm, and bead volume/(abrasive solution volume+bead volume) was adjusted to be 80% by volume, and beads mill dispersion treatment was performed for 120 minutes. The liquid after the treatment was taken out and subjected to an ultrasonic dispersion filtration treatment using a flow type ultrasonic dispersion filtration device.

The magnetic liquid, the abrasive solution, the protrusion forming agent liquid, and other components described above were put into a dissolver stirrer and stirred for 30 minutes at a circumferential speed of 10 m/sec. After that, the treatment of 3 passes was performed at a flow rate of 7.5 kg/min by a flow type ultrasonic dispersing device, and then, a composition for forming a magnetic layer was prepared by filtration using a filter having a pore diameter of 1 μm.

The composition for forming a non-magnetic layer was prepared as follows.

The components described above excluding the lubricant (stearic acid, stearic acid amide, and butyl stearate) were kneaded and diluted by an open kneader, and subjected to a dispersion treatment by a horizontal beads mill dispersing device. After that, the lubricant (stearic acid, stearic acid amide, and butyl stearate) and methyl ethyl ketone for adjusting a coating thickness were added into the obtained dispersion liquid and stirred and mixed by a dissolver stirrer to prepare a composition for forming a non-magnetic layer.

In Example 1, and Examples 2 to 8 and Comparative Examples 1 to 3 which will be described below, in a case of preparing the composition for forming a non-magnetic layer, the methyl ethyl ketone for adjusting a coating thickness was used in an amount in a range of 70.0 to 510.0 parts by mass with respect to 100.0 parts by mass of the non-magnetic powder used for preparing the composition for forming a non-magnetic layer.

The composition for forming a back coating layer was prepared as follows.

The above components excluding polyisocyanate were introduced into a dissolver stirrer, stirred at a circumferential speed of 10 m/see for 30 minutes, and then subjected to a dispersion treatment by a horizontal beads mill disperser. After that, polyisocyanate was added, and stirred and mixed by a dissolver stirrer, and a composition for forming a back coating layer was manufactured.

### Manufacture of Magnetic Tape

The composition for forming a non-magnetic layer was applied onto one surface of a biaxially stretched polyethylene naphthalate support having a thickness of 6.0 m and was dried so that the thickness after drying was the thickness shown in Table 4, and thus a non-magnetic layer was formed. The composition for forming a magnetic layer prepared above was applied onto the formed non-magnetic layer so that the thickness after the drying was the thickness shown in Table 4, and a coating layer was formed. While the coating layer of the composition for forming a magnetic layer is in a wet (undried) state, a vertical alignment treatment was performed in which a magnetic field of a magnetic field intensity of 0.15 T was applied to a surface of the coating layer in a vertical direction. After that, the coating layer was dried to form a magnetic layer. Thereafter, the composition for forming a back coating layer was applied onto a surface of the support opposite to the surface on which the non-magnetic layer and the magnetic layer are formed, and was dried, so that the thickness after drying was 0.5 m. After that, a calendering treatment was performed by using a calendering machine configured of only a metal roll, at a speed of 100 m/min, a linear pressure of 294 kN/m, and a calender temperature of 100° C. After that, a heat treatment was performed for 36 hours in an environment of an atmosphere temperature of 70° C. After the heat treatment, the layer was slit to have a width of ½ inches (1 inch=0.0254 meters) to obtain a magnetic tape.

### Examples 2 to 8 and Comparative Examples 1 to 3

A magnetic tape was manufactured by the method described for Example 1 except that the items shown in the table below were changed as shown in the table below. The thickness of the non-magnetic layer was adjusted by the amount of methyl ethyl ketone used for adjusting a coating thickness used in the preparation of the composition for forming a non-magnetic layer. The thickness of the magnetic layer was adjusted by the coating amount of the composition for forming a magnetic layer.

In Examples and Comparative Examples in which a vinyl chloride resin was used as a binding agent of the non-magnetic layer, MR-104 manufactured by Kaneka Corporation was used as the vinyl chloride resin.

Comparative Example 1 is a comparative example conforming to Example 1 of JP2020-144960A, and Comparative Example 3 is a comparative example conforming to Example 10 of JP2005-267714A.

### Evaluation Method

### Chlorine Content (Magnetic Layer+Non-Magnetic Layer) and Iron Content (Magnetic Layer+Non-Magnetic Layer)

For each of the magnetic tapes of Examples and Comparative Examples, a chlorine content (magnetic layer+non-magnetic layer) and an iron content (magnetic layer+non-magnetic layer) were obtained by the method described above.

### Void Ratio of Non-Magnetic Layer and Various Thicknesses

The sample for observing a cross section was manufactured by the method described as a specific example above. Using the manufactured sample for observing a cross section, the void ratio of the non-magnetic layer and the thickness of the magnetic layer were obtained by the method described above. The thickness of the non-magnetic layer was also obtained by the method described above as a method of measuring the thickness of the magnetic layer. FE-SEM S4800 manufactured by Hitachi, Ltd. was used as field emission-scanning electron microscope (FE-SEM) for SEM observation.

### Magnetic Layer Bm

For each of the magnetic tapes of Examples and Comparative Examples, using a vibrating sample magnetometer (manufactured by Toyo-Kogyo Co., Ltd.), a magnetization amount Φm [G·μm] was obtained by sweeping and measuring an external magnetic field in the magnetic tape under conditions of a maximum external magnetic field of 15 kOe and a scanning speed of 60 Oe/see at a measurement temperature of 23° C.±1° C.

The magnetic layer Bm was calculated as a value obtained by dividing Φm [G·μm] by the magnetic layer thickness (unit: μm) obtained as described above.

The magnetic layer Bm is preferably 1000 gauss (G) or more, and more preferably 1100 G or more, 1200 G or more, and 1300 G or more in this order. The higher the magnetic layer Bm is, the more preferable it is from the viewpoint of improving the electromagnetic conversion characteristics. In one aspect, the magnetic layer Bm may be, for example, 3000 G or less, 2500 G or less, or 2000 G or less.

### Electromagnetic Conversion Characteristics (Signal-to-Noise Ratio: SNR)

For each of the magnetic tapes of Examples and Comparative Examples, an SNR was measured using a ½ inches reel tester with a fixed head in an environment of a temperature of 23° C. and a relative humidity of 50%. A magnetic head/magnetic tape relative speed was set to 6 m/sec. For recording, a metal-in-gap (MIG) head (gap length of 0.15 m, track width of 1.0 m, 1.8 T) was used, and a recording current was set to the optimum recording current of each magnetic tape. As the reproducing head, a GMR head having an element thickness of 15 nm, a shield spacing of 0.1 m, and a track width of 1.0 m was used. A signal having a linear recording density (325 kfci) was recorded, a reproduction signal was measured using a spectrum analyzer manufactured by Shibasoku Co., Ltd., and a ratio of an output of the carrier signal to the integrated noise in the spectral full band was obtained as an SNR, which was calculated as a relative value in a case where Comparative Example 1 was used as a reference (0.0 dB). The unit kfci is a unit of the linear recording density (cannot be converted into an SI unit system). Regarding the signal, a signal which was sufficiently stabilized after starting the running of the magnetic tape was used.

### ΔSNR

The magnetic tape after the evaluation of the electromagnetic conversion characteristics was stored for 2 weeks in an environment of an atmosphere temperature of 60° C. and a relative humidity of 90%, and then the SNR was measured by the above-described method. The ΔSNR was calculated by the following expression.

ΔSNR=SNR measured after storage−SNR measured before storage

The above results are shown in the following tables.

TABLE 3

| | Non-magnetic layer | | | | | |
|---|---|---|---|---|---|---|
| | | | | | Binding agent | |
| | Non-magnetic powder | | | | Vinyl | |
| | | Compositional | | Specific | chloride | Polyurethane |
| | | ratio | | surface | resin | resin A |
| | | [parts by | | area | [parts by | [parts by |
| | Type | mass] | pH | [m²/g] | mass] | mass] |
| Comparative | Carbon black | 100 | 2.5 | 320 | 30.0 | 0.0 |
| Example 1 | | | | | | |
| Example 1 | Carbon black | 100 | 8.0 | 320 | 0.0 | 30.0 |
| Example 2 | Carbon black | 100 | 8.0 | 320 | 0.0 | 30.0 |
| Example 3 | Carbon black | 100 | 8.0 | 320 | 0.0 | 30.0 |
| Example 7 | Carbon black | 100 | 2.5 | 320 | 0.0 | 30.0 |
| Comparative | Carbon black/α- | 45/55 | 8.0/9.0 | 320/90 | 0.0 | 30.0 |
| Example 2 | iron oxide (average | | | | | |
| | particle size 50 nm) | | | | | |
| Example 4 | Carbon black/α- | 60/40 | 8.0/9.0 | 320/90 | 0.0 | 30.0 |
| | iron oxide (average | | | | | |
| | particle size 50 nm) | | | | | |
| Example 5 | Carbon black/α- | 80/20 | 8.0/9.0 | 320/90 | 0.0 | 30.0 |
| | iron oxide (average | | | | | |
| | particle size 50 nm) | | | | | |
| Example 6 | Carbon black | 100 | 8.0 | 320 | 15.0 | 15.0 |
| Example 8 | Carbon black | 100 | 3.5 | 260 | 0.0 | 30.0 |
| Comparative | Carbon black/α- | 20/85 | 8.0/8.0 | 250/52 | 1.7 | 10.0 |
| Example 3 | iron oxide (average | | | | | |
| | particle size 150 | | | | | |
| | nm) | | | | | |

TABLE 4

| | | | Non-magnetic | | | Chlorine | | |
|---|---|---|---|---|---|---|---|---|
| | | | layer | | Iron content | content | | |
| | Magnetic layer | | Non- | | (magnetic | (magnetic | | |
| | Magnetic | | magnetic | | layer + non- | layer + non- | | |
| | layer | | layer | Void | magnetic | magnetic | Evaluation result | |
| | thickness | Bm | thickness | ratio | layer) | layer) | SNR | ΔSNR |
| | [nm] | [G] | [μm] | [%] | [mg/m²] | [mg/m²] | [dB] | [dB] |
| Comparative | 70 | 1350 | 0.40 | 2.5 | 99.8 | 67.3 | 0.0 (reference) | −2.5 |
| Example 1 | | | | | | | | |
| Example 1 | 70 | 1620 | 0.40 | 2.0 | 99.8 | 6.1 | 0.7 | 0.0 |
| Example 2 | 70 | 1580 | 0.10 | 1.5 | 99.8 | 6.1 | 0.7 | 0.0 |
| Example 3 | 70 | 1500 | 0.80 | 3.5 | 99.8 | 6.1 | 0.4 | 0.0 |
| Example 7 | 70 | 1020 | 0.40 | 12.6 | 99.8 | 6.1 | −1.3 | 0.0 |
| Comparative | 70 | 1280 | 0.40 | 9.8 | 320.0 | 6.1 | −0.5 | −1.8 |
| Example 2 | | | | | | | | |
| Example 4 | 70 | 1230 | 0.40 | 9.2 | 280.0 | 6.1 | −0.5 | 0.0 |
| Example 5 | 70 | 1300 | 0.40 | 6.3 | 180.0 | 6.1 | 0.0 | 0.0 |
| Example 6 | 70 | 1330 | 0.40 | 5.5 | 99.8 | 28.0 | 0.0 | 0.0 |
| Example 8 | 70 | 1100 | 0.40 | 18.0 | 99.8 | 6.1 | −1.0 | 0.0 |
| Comparative | 80 | 850 | 1.90 | 23.0 | 1950.0 | 33.9 | −2.8 | −3.0 |
| Example 3 | | | | | | | | |

From the results shown in Table 4, it can be confirmed that the magnetic tapes of Examples 1 to 8 have little deterioration in electromagnetic conversion characteristics after storage under severe conditions.

One aspect of the present invention is useful in the technical field of various magnetic recording media such as a magnetic tape for data storage.

What is claimed is:

1. A magnetic recording medium comprising:
a non-magnetic support;
a magnetic layer containing a ferromagnetic powder; and
a non-magnetic layer containing a non-magnetic powder between the non-magnetic support and the magnetic layer,
wherein a total chlorine content of the magnetic layer and the non-magnetic layer is 30.0 mg/m² or less as a value per unit area, and
a total iron content of the magnetic layer and the non-magnetic layer is 300.0 mg/m² or less as a value per unit area.

2. The magnetic recording medium according to claim 1,
wherein a void ratio of the non-magnetic layer is 10.0% or less in a cross section image captured by a scanning electron microscope.

3. The magnetic recording medium according to claim 1,
wherein the non-magnetic powder of the non-magnetic layer includes carbon black.

4. The magnetic recording medium according to claim 3,
wherein the non-magnetic layer contains 50.0% by mass or more of carbon black with respect to a total amount of the non-magnetic powder.

5. The magnetic recording medium according to claim 1,
wherein a thickness of the non-magnetic layer is 1.00 m or less.

6. The magnetic recording medium according to claim 1, further comprising:
a back coating layer containing a non-magnetic powder on a surface side of the non-magnetic support opposite to a surface side having the non-magnetic layer and the magnetic layer.

7. The magnetic recording medium according to claim 1,
wherein the magnetic recording medium is a magnetic tape.

8. The magnetic recording medium according to claim 1,
wherein a void ratio of the non-magnetic layer is 10.0% or less in a cross section image captured by a scanning electron microscope,
the non-magnetic layer contains 50.0% by mass or more of carbon black with respect to a total amount of the non-magnetic powder,
a thickness of the non-magnetic layer is 1.00 m or less,
the magnetic recording medium further comprises a back coating layer containing a non-magnetic powder on a surface side of the non-magnetic support opposite to a surface side having the non-magnetic layer and the magnetic layer, and
the magnetic recording medium is a magnetic tape.

9. A magnetic tape cartridge comprising:
the magnetic tape according to claim 7.

10. A magnetic recording and reproducing device comprising:
the magnetic recording medium according to claim 1.
